(19) United States
(12) Patent Application Publication
(10) Pub. No.: US 2019/0068489 A1
(43) Pub. Date: Feb. 28, 2019

(54) USE OF DIRECTIONALITY TO REDUCE FLOODING IN A WIRELESS MESH NETWORK

(71) Applicant: QUALCOMM Incorporated, San Diego, CA (US)

(72) Inventors: Ravi SHEKHAR, Thubarahalli (IN); Sourabh JANA, Bangalore (IN); Srivathsa SRIDHARA, Bhadravathi (IN)

(21) Appl. No.: 15/693,468

(22) Filed: Aug. 31, 2017

(51) Int. Cl. H04L 12/721

(52) U.S. Cl. CPC H04L 45/32; H04W 84/18

(57) ABSTRACT

The disclosure generally relates to using directionality to reduce flooding in a wireless mesh network. In an aspect, a node of the wireless mesh network receives a message for a destination node in the wireless mesh network, determines whether or not the message came from a direction of the destination node, drops the message based on determining that the message came from the direction of the destination node, and forwards the message based on determining that the message did not come from the direction of the destination node.

### TECHNICAL FIELD

The various aspects described herein generally relate to wireless communications, and in particular, to using directionality to reduce flooding in a wireless mesh network.

### BACKGROUND

All wireless networking technologies generally have a limited range. However, there are many environments in which devices that are otherwise outside communication range may need to communicate using a reliable low-power wireless technology. For example, the Internet of Things (IoT) is based on the idea that everyday objects, not just computers and computer networks, can be read, recognized, located, addressed, and otherwise controlled via an IoT communications network (e.g., an ad-hoc system or the Internet). One way to address issues that arise when devices are outside a maximum communication range is to implement a mesh network, which has a topology in which all devices can communicate with another either directly or indirectly. For example, two devices that are in radio range may communicate directly, whereas communication with devices located outside radio range may be achieved via one or more intermediate “relay” nodes. Mesh networks may therefore offer multiple paths to route a message from a source to a destination, resulting in greater reliability relative to other networks that tend to flow all traffic through a central hub (e.g., a router or gateway).

Accordingly, a wireless mesh network may generally refer to a network in which various devices or nodes have the ability to receive and act upon messages in addition to having the ability to repeat or relay the messages to surrounding devices or nodes that are within radio range. The mesh architecture may therefore extend the effective radio range associated with whatever wireless technology is used to convey the messages, whereby the mesh architecture can be used to implement the IoT and other suitable use cases that are built at least in part on wireless communications. In general, a wireless mesh network can use a routing protocol to find a path to convey a message from one node to another. Alternatively and/or additionally, a flooding protocol may be used. In a flooding protocol, each node may send a message to every other node in radio range, and the other nodes may in turn relay the message to each node in radio range thereof. Consequently, the message may be suitably relayed to all nodes in the mesh network. One advantage that may result from using a flooding approach is that less memory and processing power (and therefore less energy) may be required.

Although flooding may offer various advantages in a wireless mesh network, flooding protocols also present various challenges. For example, some wireless technologies may use a flooding protocol in which each message is sent to every other node arbitrarily even though some messages may only have one intended destination. As such, each node may eventually receive the same flooded message from each neighbor located at a next hop level. In that sense, the duplicate messages may increase the overall load as well as the processing complexity in the wireless mesh network. As the number of nodes in the wireless mesh network increases, using such a flooding protocol may be expected to result in decreased network reliability. One proposed approach to restrict the unlimited message circulation of a flooded message in a wireless mesh network is to use a message cache along with a hop count or time-to-live (TTL) value. However, in a large wireless mesh network, the message cache may be unable to eradicate flooding of duplicate messages. For example, when a transmitting node does not know the approximate hop count to a destination node, the transmitting node might choose a high TTL value. Furthermore, any relay nodes that transmit the flooded message to the originating/transmitting node may contribute to unnecessarily circulating the message.

Accordingly, there exists a need to develop devices, apparatus, and methods to improve flooding and otherwise improve performance in a wireless mesh network.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of using directionality to reduce flooding in a wireless mesh network includes receiving, at a node of the wireless mesh network, a message for a destination node in the wireless mesh network, determining, by the node, whether or not the message came from a direction of the destination node, based on determining that the message came from the direction of the destination node, dropping, by the node, the message, and based on determining that the message did not come from the direction of the destination node, forwarding the message.

In an aspect, an apparatus for using directionality to reduce flooding in a wireless mesh network includes a receiver of a node in the wireless mesh network configured to receive a message for a destination node in the wireless mesh network, and at least one processor of the node configured to: determine whether or not the message came from a direction of the destination node, drop the message based on a determination that the message came from the direction of the destination node, and cause a transmitter of the apparatus to forward the message based on a determination that the message did not come from the direction of the destination node.

In an aspect, an apparatus for using directionality to reduce flooding in a wireless mesh network includes a means for communication of a node in the wireless mesh network configured to receive a message for a destination node in the wireless mesh network, and a means for processing of the node configured to: determine whether or not the message came from a direction of the destination node, drop the message based on a determination that the message came from the direction of the destination node, and cause a transmitter of the apparatus to forward the message based on a determination that the message did not come from the direction of the destination node.

In an aspect, a non-transitory computer-readable medium storing computer-executable instructions for using directionality to reduce flooding in a wireless mesh network includes computer-executable instructions comprising at least one instruction instructing a node of the wireless mesh network to receive a message for a destination node in the wireless mesh network, at least one instruction instructing the node to determine whether or not the message came from a direction of the destination node, at least one instruction instructing the node to drop the message based on a determination that the message came from the direction of the destination node, and at least one instruction instructing the node to forward the message based on a determination that the message did not come from the direction of the destination node.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless mesh network in which the various aspects described herein may be suitably implemented.

FIG. 2 illustrates an exemplary environment in which a wireless mesh network implementing the various aspects described herein may be deployed.

FIG. 3 illustrates an exemplary network graph to depict a message flow path in a wireless mesh network that uses a flooding protocol, according to various aspects.

FIG. 4 illustrates exemplary packet structures that may be used to communicate messages in a wireless mesh network, according to various aspects.

FIG. 5 illustrates an example wireless mesh network in which the nodes can determine the AOA to the source node of a message, according to at least one aspect of the disclosure.

FIG. 6 illustrates an example wireless mesh network in which the intermediate nodes can determine to forward or drop a message to a destination node based on the AOA of the message, according to at least one aspect of the disclosure.

FIG. 7 illustrates an example wireless mesh network in which the intermediate nodes can beam a received message along the AOA associated with the destination node, according to at least one aspect of the disclosure.

FIG. 8 illustrates an exemplary flow that may be performed by a node in a wireless mesh network according to at least one aspect of the disclosure.

FIG. 9 illustrates an exemplary method for using directionality to reduce flooding in a wireless mesh network according to at least one aspect of the disclosure.

FIG. 10 illustrates an exemplary device configured as a mesh network node in accordance with the various aspects described herein.

### DETAILED DESCRIPTION

The disclosure generally relates to using directionality to reduce flooding in a wireless mesh network. In an aspect, a node of the wireless mesh network receives a message for a destination node in the wireless mesh network, determines whether or not the message came from a direction of the destination node, drops the message based on determining that the message came from the direction of the destination node, and forwards the message based on determining that the message did not come from the direction of the destination node.

These and other aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user device,” “user equipment” (or “UE”), “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device. Accordingly, the above-mentioned terms may suitably refer to any one or all of cellular telephones, smart phones, personal or mobile multimedia players, personal data assistants, laptop computers, personal computers, tablet computers, smart books, palm-top computers, wireless electronic mail receivers, multimedia Internet-enabled cellular telephones, wireless gaming controllers, and similar devices with a programmable processor, memory, and circuitry to connect to and communicate over a radio access network (RAN) that implements a particular radio access technology (RAT), over a wired network, over a wireless local area network (WLAN) (e.g., based on IEEE 802.11, etc.), and/or with other devices via a direct device-to-device (D2D) or peer-to-peer (P2P) connection (e.g., a Bluetooth connection).

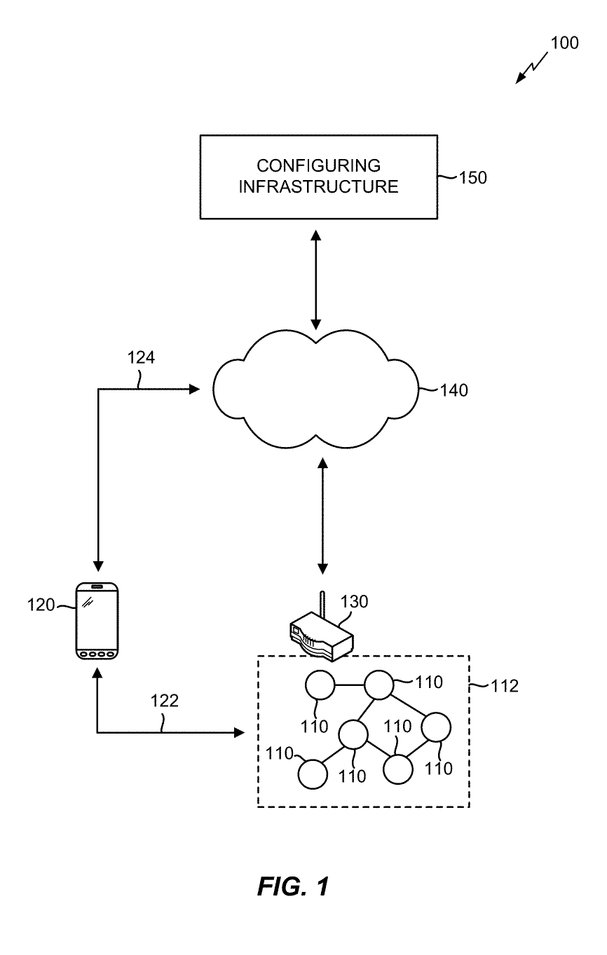

According to various aspects, FIG. 1 illustrates an exemplary wireless mesh network 100 in which the various aspects described herein may be suitably implemented. More particularly, the example wireless mesh network 100 may comprise various nodes 110, which may optionally be organized as a group 112, a controller 120 (e.g., a mobile device), a gateway 130, and a configuring infrastructure 150 in communication via a network cloud 140. Furthermore, although the controller 120 and the gateway 130 are depicted in FIG. 1 as elements separate from the nodes 110, those skilled in the art will appreciate that the controller 120 and/or the gateway 130 can be included among the nodes 110 in various aspects. In general, the nodes 110 may be the basic building blocks of the wireless mesh network 100, wherein the nodes 110 may comprise any suitable device that can be configured to send, receive, and relay messages to surrounding nodes 110 (i.e., devices). In various aspects, message communication among the nodes 110 may generally be based on broadcast messages, which may be transmitted via one or more wireless channels.

According to various aspects, the controller 120 may be configured to establish a wireless connection 122 with the nodes 110, whereby the controller 120 may use a wireless radio to communicate with the nodes 110 in the wireless mesh network 100. Furthermore, in various aspects, the controller 120 may have an additional communication path 124 to the wireless mesh network 100. For example, in various aspects, the controller 120 may use a configuring application to communicate with the configuring infrastructure 150 via the additional communication path 124 (e.g., via a web console or service). As such, the configuring infrastructure 150 may service configuration commands received from the controller 120 (e.g., to securely distribute a network key to a new node 110, to program a particular node 110 to be within the group 112 or another group, etc.). In various aspects, the gateway 130 may link the various nodes 110 to the cloud 140 and allow command and control over a local area network (LAN) or wireless LAN (WLAN) to which the gateway 130 is connected. Like other elements in the wireless mesh network 100, the gateway 130 may also use a wireless radio to communicate with the various nodes 110 via a wireless channel. According to various aspects, the wireless mesh network 100 may enable the nodes 110 to send, receive, and/or relay messages (e.g., command and control operations), which may originate at one or more of the nodes 110 and/or be received from the controller 120 via the wireless connection 122 or from the gateway 130 via the additional communication path 124 between the controller 120 and the nodes 110.

According to various aspects, at least the nodes 110, the controller 120, and the gateway 130 may be configured to communicate with one another via a wireless mesh protocol, which may generally enable devices to send, receive, and relay messages to surrounding devices located within radio range, thus forming an ad-hoc mesh network. For example, message communication may be based on broadcast messages transmitted and received via one or more wireless channels (e.g., a Bluetooth broadcast channel), wherein each node 110 that receives a broadcast message may accept and forward the message to other nodes 110 within radio range. In this manner, the range over which the nodes 110 can communicate may be easily extended, as one or more intermediate nodes 110 can be used to relay a message to another node 110 that is otherwise located outside radio range. As such, the wireless mesh protocol may enable the wireless mesh network 100 to be easily extended to accommodate new devices, which can also increase the geographic coverage of the wireless mesh network 100 depending on device placement. The wireless mesh protocol can therefore be used to support various different use cases that are built, at least in part, on point-to-point, point-to-multipoint, and/or other suitable wireless communications.

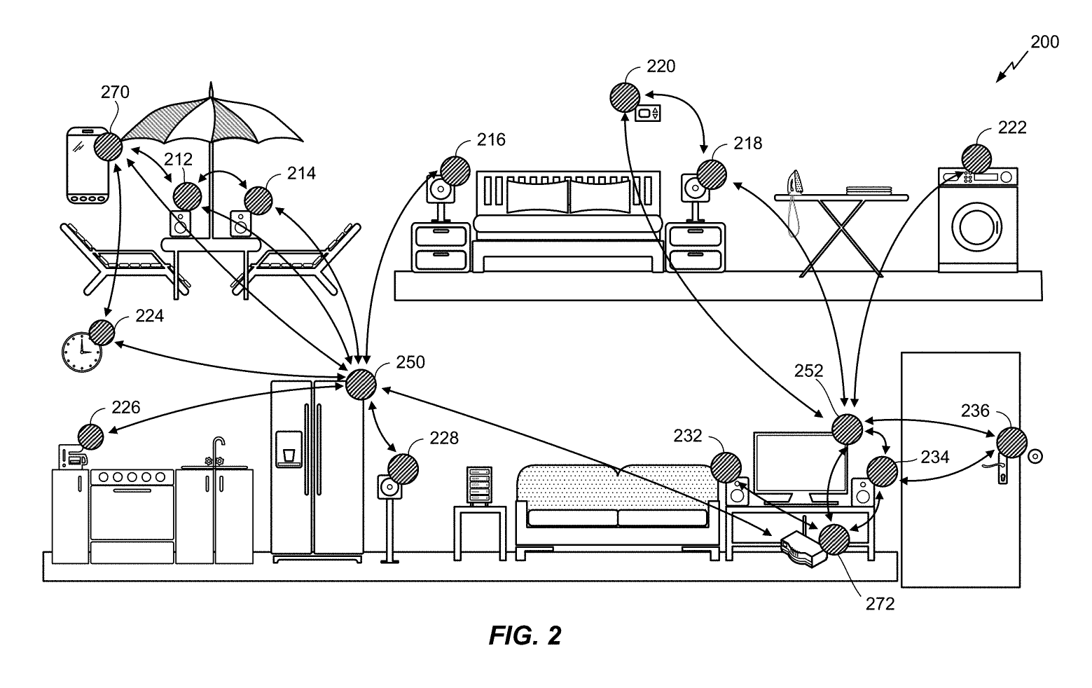

According to various aspects, FIG. 2 illustrates one exemplary environment 200 in which a wireless mesh network may be suitably implemented. In the exemplary environment 200 shown in FIG. 2, the wireless mesh network supports a home automation or an IoT use case, where home appliances, lights, electrical switches, thermostats, etc. can form a wireless mesh network and be controlled via the wireless mesh protocol, either directly using one or more user devices or indirectly via a gateway device in communication with the one or more user devices (e.g., a smartphone, a laptop computer, etc.). For example, the particular environment 200 as shown in FIG. 2 includes a smartphone 270, outdoor speakers 212 and 214, bedroom speakers 216 and 218, a thermostat 220, a laundry machine 222, a clock 224, a coffee machine 226, a refrigerator 250, a kitchen speaker 228, family room speakers 232 and 234, a television 252, an electronic lock 236, and a home gateway device 272. The various devices may communicate with other devices within sufficient range (e.g., via broadcast messages) and the messages may be received and relayed as appropriate to ensure that the message(s) reach the intended destination. For example, in the environment 200 shown in FIG. 2, a user may press a button on the smartphone 270 to engage the electronic lock 236, which is located outside radio range from the smartphone 270. However, the smartphone 270 is within radio range from the outdoor speakers 212 and 214, the clock 224, and the refrigerator 250. Accordingly, the smartphone 270 may broadcast a message containing a command to engage the electronic lock 236, and the outdoor speakers 212 and 214, the clock 224, and the refrigerator 250 may each relay the message until the message eventually reaches the electronic lock 236.

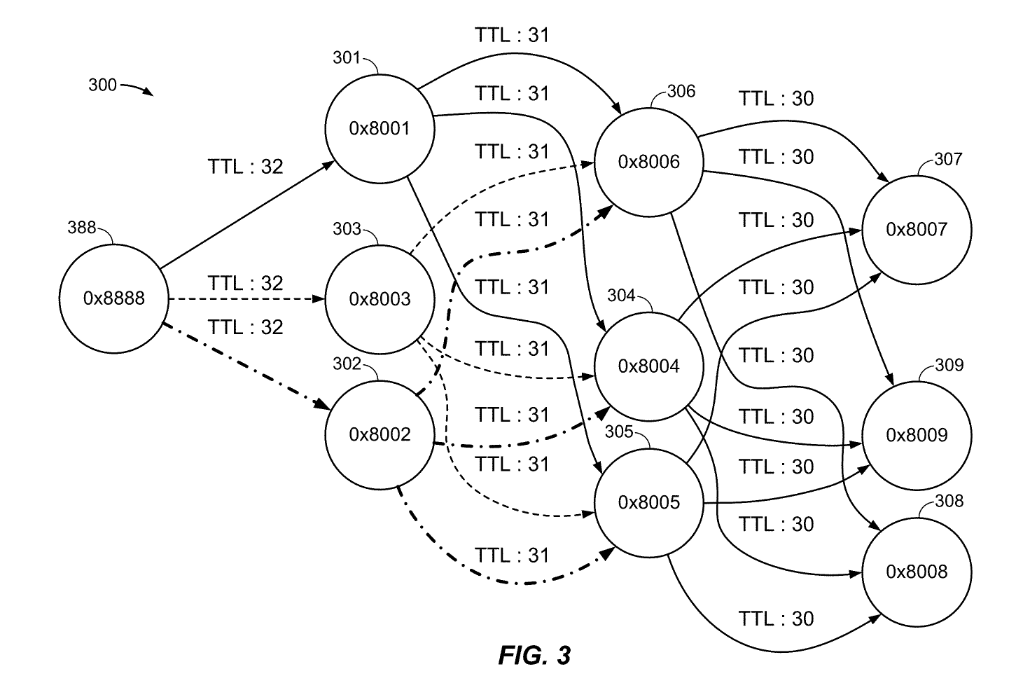

In various aspects, as noted above, communication in the wireless mesh network 100 as shown in FIG. 1, the IoT environment 200 as shown in FIG. 2, and/or other suitable mesh network environments may generally be based on a wireless mesh protocol. For example, in various aspects, a routing protocol can be used to find a path to convey a message from one node in the wireless mesh network to another node in the wireless mesh network. Alternatively and/or additionally, a flooding protocol may be used. In a flooding protocol, each node may send a message to every other node in radio range, and the other nodes may in turn relay the message to each node in radio range thereof. Consequently, the message may be suitably relayed to all nodes in the wireless mesh network. For example, FIG. 3 illustrates an exemplary network graph 300 to depict a message flow path in a wireless mesh network that uses a flooding protocol.

More particularly, the example network graph 300 shown in FIG. 3 includes node 388 at a first hop level, nodes 301, 302, and 303 at a second hop level, nodes 304, 305, and 306 at a third hop level, and nodes 307, 308, and 309 at a fourth hop level. As noted above, devices may generally broadcast messages in the wireless mesh network over a suitable wireless channel (e.g., a Bluetooth advertising channel). Messages may then be routed through the wireless mesh network using the flooding protocol with assistance from various nodes implementing relay functionality. For example, the node 388 at the first hop level may broadcast a message for which node 308 is the intended destination. The broadcasted message may therefore be received at the nodes 301, 302, and 303 at the next hop level, which may each receive and relay the message to the nodes 304, 305, and 306 at the next hop level and so on until the message reaches the intended destination node 308.

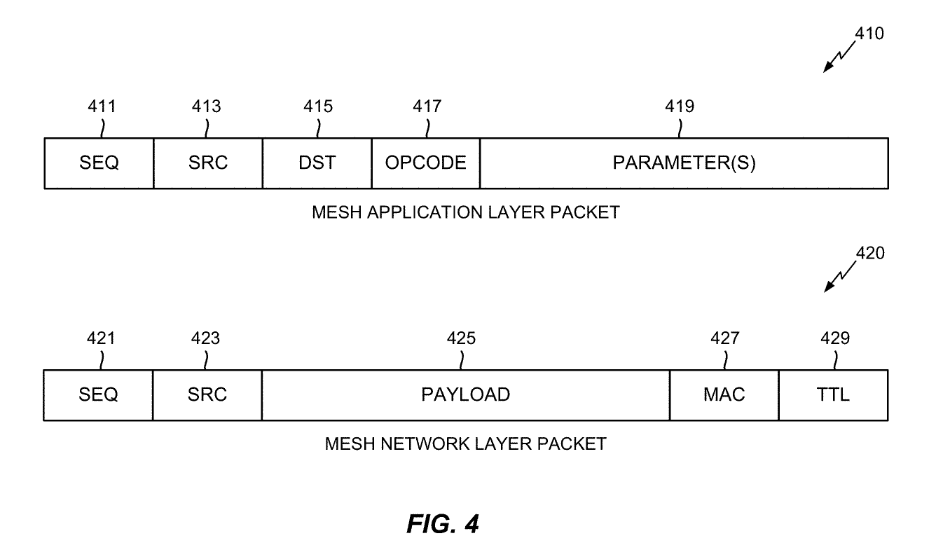

FIG. 4 illustrates exemplary packet structures 410 and 420 that may be used to communicate messages in a wireless mesh network according to at least one aspect of the disclosure. More particularly, FIG. 4 illustrates a mesh application layer packet 410, which may include a sequence (SEQ) number 411, a source (SRC) identifier 413 associated with a message originator, a destination (DST) identifier 415 associated with the destination of the message, a message opcode 417, and one or more message parameters 419.

Although flooding a message may advantageously offer simplicity and consume less memory and processing power (and therefore less energy), such a naïve flooding protocol presents various challenges. For example, a naïve flooding protocol may promote duplicate messages because each message has to be arbitrarily sent to every other node even if the message only has one intended destination. As such, each node may eventually receive the same flooded message from each neighbor located at a next hop level. In that sense, the duplicate messages may increase the overall load as well as the processing complexity in the wireless mesh network. As the number of nodes in the wireless mesh network increases, using the naïve flooding protocol may be expected to result in greater and greater reductions in network reliability.

One approach to restrict the unlimited message circulation of a flooded message in a wireless mesh network may be to use a message cache along with a hop count or time-to-live (TTL) value. As such, referring back to FIG. 4, a mesh network layer packet 420 may include a sequence (SEQ) number 421, a source (SRC) identifier 423, an encrypted payload 425, a message access code (MAC) 427, and a TTL value 429. For example, after the mesh application layer packet 410 has been encrypted and authenticated, the MAC 427 (e.g., an eight octet field) may be produced to confirm the integrity of the message. As such, if a message is identical to another message, the MAC 427 will also be identical. In the message cache solution mentioned above, a node may be configured to discard, without relaying, any message with a MAC 427 that matches the MAC 427 associated with a previous message stored in the message cache, which may help to reduce flooding. For example, referring to FIG. 3, the nodes 304, 305, and 306 may only relay the message from node 301 and may not relay the identical messages that are received from nodes 302 and 303.

However, in a large wireless mesh network, the message cache may be unable to eradicate flooding of duplicate messages. For example, constrained memory may be unable to maintain a large enough cache of messages to prevent duplication. Furthermore, when a transmitting node does not know the approximate hop count to a destination node, the transmitting node might choose an unnecessarily high TTL value 429, which would otherwise limit the number of times that the message can be relayed in the network (e.g., each time that a device receives and relays a message, the TTL value 429 is decremented by one without re-computing the MAC 427). Although the message would not be relayed when the TTL value 429 reaches one (1) (e.g., because a TTL value 429 of zero (0) is used to communicate with neighboring devices), this may also fail to reduce flooding. Users and/or applications may therefore select a suboptimal TTL value 429, as the size of a given wireless mesh network is not static, and instead set the TTL value 429 to the maximum value. For example, simple math suggests that a message that has to be relayed from a first level (L1) having a first number (N1) of nodes to a second level (L2) having a second number (N2) of nodes will result in N1*N2 messages transmitted from L1 to L2.

Accordingly, the present disclosure provides a mechanism to use directionality to reduce the amount of flooding in a wireless mesh network. In an aspect, each node in a wireless mesh network determines, for each incoming message, at least the source node (e.g., from the SRC identifier 413 field in FIG. 4) and the angle of arrival (AOA) of the message. The node can then store an association between the node identified as the source node and the AOA of the message in an AOA Table. In that way, over time, the node can determine the AOA to each node from which it receives a message. Note that although the AOA of the message is the AOA of the node from which the message is received, which may not be the source node for that message, the receiving node treats it as the AOA from the source node. The reason for this is that the receiving node may not be able to identify the node from which the message was received, as this information is not necessarily included in the message or signaling information from the sending node. It also reduces the amount of information a node needs to store. By simply associating the source of a message with the AOA of the message, the node will know the direction from itself to the source node, and does not need to know the hops, if any, between the node and the source node.

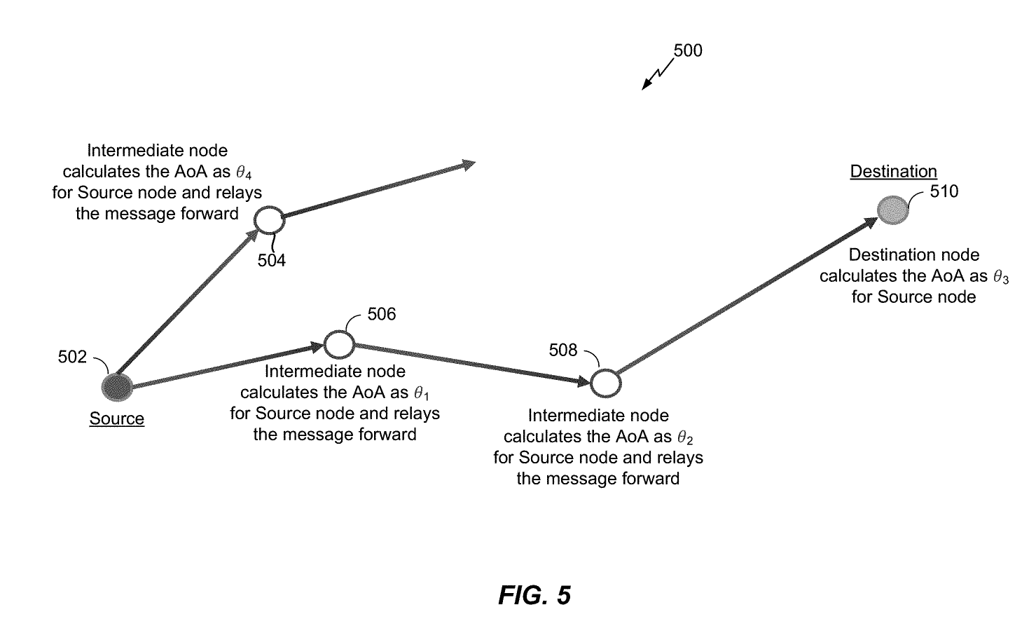

FIG. 5 illustrates an example wireless mesh network 500 in which the nodes can determine the AOA to the source node of a message, according to at least one aspect of the disclosure. As illustrated in FIG. 5, a source node 502 broadcasts a message to intermediate nodes 504 and 506. The intermediate node 506 calculates the AOA of the message as θ₁, determines that it is not the destination node, and relays (i.e., broadcasts) the message (to intermediate node 508 in the example of FIG. 5). The intermediate node 506 also stores an association between an identifier of the source node 502 and the AOA θ₁ in an AOA Table (e.g., <SRC identifier 413, AOA θ₁>). Similarly, the intermediate node 504 calculates the AOA of the message as θ₄, determines that it is not the destination node, and relays (i.e., broadcasts) the message. The intermediate node 504 also stores an association between an identifier of the source node 502 and the AOA θ₄ in an AOA Table (e.g., <SRC identifier 413, AOA θ₄>).

The intermediate node 508 receives the message broadcasted by the intermediate node 506, calculates the AOA of the message as θ₂, determines that it is not the destination, and therefore relays the message (to destination node 510 in the example of FIG. 5). The intermediate node 508 also stores an association between an identifier of the source node 502 and the AOA θ₂ in an AOA Table (e.g., <SRC identifier 413, AOA θ₂>). The destination node 510 receives the message broadcasted by the intermediate node 508, calculates the AOA of the message as θ₃, determines that it is the destination, and therefore does not relay the message. The destination node 510 also stores an association between an identifier of the source node 502 and the AOA θ₃ in an AOA Table (e.g., <SRC identifier 413, AOA θ₂>).

Note that although FIG. 5 only illustrates three intermediate nodes 504 to 508, as will be appreciated, there may be more or fewer than three intermediate nodes 504 to 508. In addition, although FIG. 5 illustrates that the source node 502 broadcasts the message to two intermediate nodes (504 and 506) and intermediate nodes 506 and 508 broadcast the message to only one other node, as will be appreciated, each node may broadcast the message to more than one other node, depending on the layout of, and the number of nodes in, the wireless mesh network 500. Similarly, although FIG. 5 illustrates that there are no further nodes to receive the message broadcasted by the intermediate node 504, as will be appreciated, there may be other nodes to receive the message broadcasted by the intermediate node 504.

Further note that a node may receive the same message from a source node from different intermediate nodes, and/or may receive different messages from the same source node from different intermediate nodes. As such, there may be different AOAs associated with the same source node. To address this issue, so that there is only one AOA in the AOA Table per source node, the receiving node can determine the AOA for the source node to be the AOA of the first message received from the source node. This assumes that the first-arriving message will have taken the most direct route. Alternatively, the receiving node can determine the AOA for the source node to be some combination (e.g., an average) of the AOAs of some number of messages (e.g., the first three, five, all) received from the source node. This could be beneficial where nodes are close together and there is little difference between the time of arrival of the message from the different intermediate nodes. It may also be beneficial where the node is not able to determine the AOA of the message with precision. By taking the average of some number of AOAs, provided the AOAs are within some threshold of each other that would indicate that the associated messages are from the same node, a more precise AOA for a source node can be determined. As yet another alternative, the receiving node can determine the AOA for the source node to be an approximate range that includes the AOAs of some number of messages (e.g., the first three, ten, all) received from the source node. Again, this could be beneficial where nodes are close together and there is little difference between the time of arrival of the message from the different intermediate nodes. A receiving node could also implement some combination of these three alternatives.

Once a node has generated the AOA Table associating the identifiers of source nodes with the AOAs of messages received from those source nodes, then for each incoming message, the node can determine whether or not the message came from the direction of the node identified in the message as the destination node (e.g., in the DST identifier 415 field in FIG. 4) based on the information in the AOA Table. If it did, the node can drop the message (i.e., refrain from forwarding/relaying/broadcasting the message) because it can assume that the destination node has already received the message. More specifically, if the message came from the direction of the destination node, the receiving node can assume that the destination node already received the message from another node in the wireless mesh network, and therefore, there is no need to relay the message further. If the message did not come from the direction of the destination node, however, the node can forward the message.

Note that although the AOA Table has been described as being populated with identifiers of source nodes, the identifiers stored in the AOA Table are simply identifiers of nodes and do not limit the nodes to being source nodes. Rather, the identified nodes may at times operate as source nodes and at other times as destination nodes. For example, a node X may originate a message. As such, its identifier, “X,” will be in the SRC identifier 413 field of the message. At some later time, the node X may be the destination of a different message. As such, its identifier, “X,” will be in the DST identifier 415 field of the message. Accordingly, although populated using the identifier of the source node, the AOA Table can be used to lookup the identifier of a destination node.

A node can determine whether the destination node is in the direction from which the message arrived based on the information in the AOA Table. For example, the node can look up the identifier of the destination node in the AOA Table, and identify the AOA associated with the destination node in the AOA Table. If the received message came from the AOA associated with the destination node, the receiving node can drop the message. However, if the received message came from a different AOA than the AOA associated with the destination node, the receiving node can forward the message.

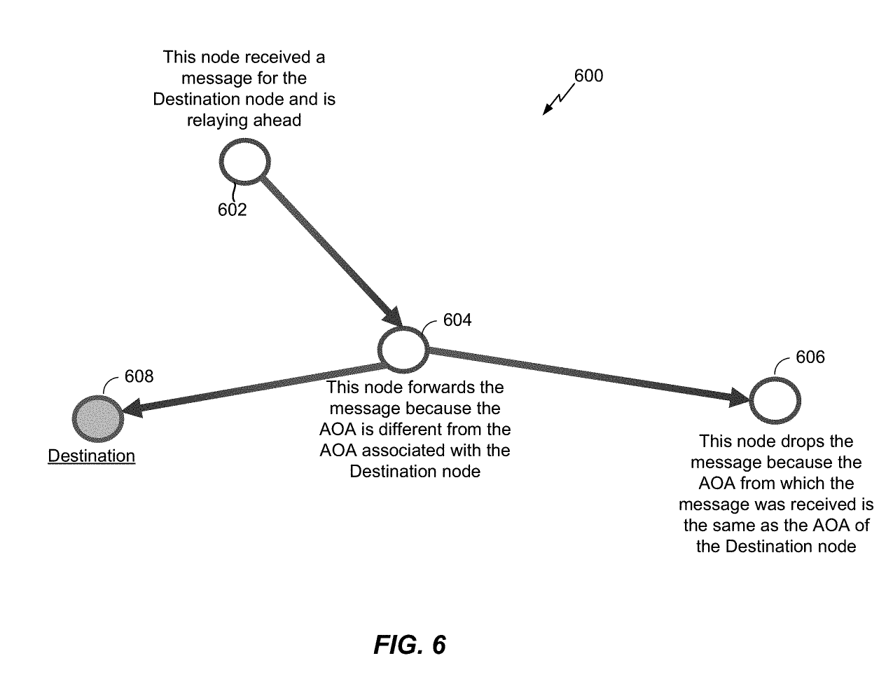

FIG. 6 illustrates an example wireless mesh network 600 in which the intermediate nodes can determine to forward or drop a message to a destination node based on the AOA of the message, according to at least one aspect of the disclosure. As illustrated in FIG. 6, a node 602 receives a message for the destination node 608 and relays (i.e., broadcasts) the message within the wireless mesh network 600. In an aspect, the node 602 may have originated the message, received it from another node in the wireless mesh network 600, or received it from another device, such as the controller 120 in FIG. 1.

In the example of FIG. 6, an intermediate node 604 receives the message broadcasted by the node 602. The intermediate node 604 determines whether the destination node 608 is in the direction from which the message arrived based on the AOA of the message. Specifically, the intermediate node 604 looks up the identifier of the destination node 608 in its AOA Table, identifies the AOA associated with the destination node 608, and determines whether the AOA of the message is the same as or different from the AOA associated with the destination node 608. In the example of FIG. 6, the AOAs are different, and thus, the intermediate node 604 relays the message within the wireless mesh network 600.

As shown in FIG. 6, both the destination node 608 and a node 606 receive the message broadcasted by the intermediate node 604. The node 606 determines whether the destination node 608 is in the direction from which the message arrived based on the AOA of the message and the AOA associated with the destination node 608 stored in the AOA Table of the node 606. Specifically, the node 606 looks up the identifier of the destination node 608 in its AOA Table, identifies the AOA associated with the destination node 608, and determines whether the AOA of the message is the same as or different from the AOA associated with the destination node 608 stored in the AOA Table. In the example of FIG. 6, the AOAs are the same because any message received at the node 606 from the destination node 608 would have been received from the intermediate node 604. Thus, the node 606 would have associated in its AOA Table the identifier of the destination node 608 with the AOA of messages received from the intermediate node 604. Because the AOAs are the same, the node 606 drops the received message.

Using the AOA of a message to determine whether to forward or drop the message reduces the amount of flooding in a wireless mesh network as compared to the message caching and TTL techniques. In the message caching technique, a node does not know the relative position of the destination node (e.g., the angle to the destination node), so after receiving any new message (i.e., a message with a MAC 427 that does not match the MAC 427 associated with a previous message stored in the message cache), the node relays the message even though the message may have come from the direction of the destination node and therefore the destination node likely already received the message. In contrast, a node using the AOA techniques described herein would not relay the message if it came from the direction of the destination node, thereby reducing the number of messages being transmitted in the wireless mesh network. Compared to the TTL technique, where a message is relayed within a wireless mesh network a certain number of times, using the AOA techniques described herein, a node would not relay the message if it came from the direction of the destination node, even if the TTL would otherwise permit additional relays. As such, the AOA techniques described herein can provide a significant reduction in the amount of traffic being broadcasted in a wireless mesh network compared to conventional techniques.

When relaying a message, an intermediate node can broadcast the message omni-directionally (i.e., in all directions, as illustrated, for example, in FIG. 6) or, where an intermediate node is capable of beaming wireless communications in a particular direction (e.g., where the node includes one or more directional antennas), the node can beam the message along the AOA associated with the destination node. Specifically, upon receiving a new message, the node can determine whether the destination node is in the direction from which the message arrived based on the AOA of the message, as discussed above. If the message did not come from the direction of the destination node, the node can beam the message along the AOA associated with the destination node stored in the intermediate node's AOA Table.

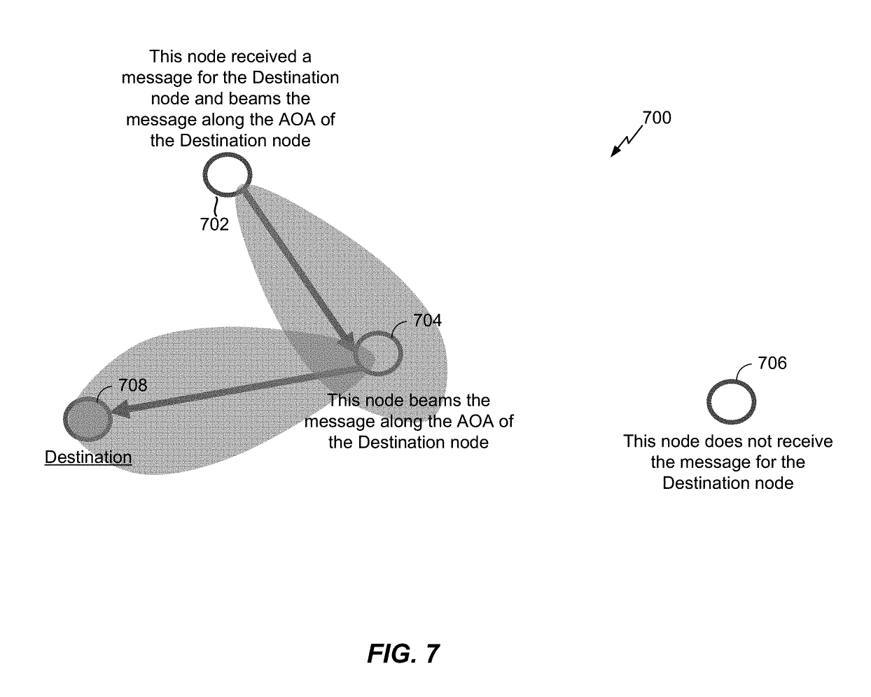

FIG. 7 illustrates an example wireless mesh network 700 in which the intermediate nodes can beam a received message along the AOA associated with the destination node, according to at least one aspect of the disclosure. As illustrated in FIG. 7, a node 702 receives a message for the destination node 708. In an aspect, the node 702 may have originated the message, received it from another node in the wireless mesh network 700, or received it from another device, such as the controller 120 in FIG. 1. The node 702 then beams the message in the direction of the destination node 708.

More specifically, the node 702 looks up the identifier of the destination node 708 in its AOA Table, identifies the AOA associated with the destination node 708, and beams the message in the direction of the AOA associated with the destination node 708. In the example of FIG. 7, any message received at the node 702 from the destination node 708 would have been received from the intermediate node 704. Thus, the node 702 would have associated in its AOA Table the identifier of the destination node 708 with the AOA of messages received from the intermediate node 704. As such, to beam the message in the direction of the destination node 708, the node 702 beams the message in the direction of the intermediate node 704.

As illustrated in FIG. 7, the intermediate node 704 receives the message beamed by the node 702. Because the intermediate node 704 may not know that the message was directionally beamed to it as a hop from the node 702 to the destination node 708, the intermediate node 704 first determines whether the destination node 708 is in the direction from which the message arrived based on the AOA of the message. More specifically, the intermediate node 704 looks up the identifier of the destination node 708 in its AOA Table, identifies the AOA associated with the destination node 708, and determines whether the AOA of the message is the same as or different from the AOA associated with the destination node 708. In the example of FIG. 7, the AOAs are different, and thus, the intermediate node 704 beams the message in the direction of the AOA associated with the destination node 708. In the example of FIG. 7, the intermediate node 704 is within communication range of the destination node 708, and as such, the AOA associated with the destination node 708 in the AOA Table of the intermediate node 704 would be the actual angle between the intermediate node 704 and the destination node 708.

As shown in FIG. 7, another node, node 706, is part of the wireless mesh network 700 but does not receive the message for destination node 708 because nodes 702 and 704 are able to beam the message to the destination node 708, rather than broadcasting it omni-directionally, as in FIG. 6. As such, where one or more nodes in a wireless mesh network (e.g., wireless mesh network 700) are able to beam messages in a particular direction, the flooding of messages in the wireless mesh network can be further reduced compared to a wireless mesh network (e.g., wireless mesh network 600) in which nodes broadcast messages omni-directionally. Note that not every node in a wireless mesh network needs to be capable of beaming wireless communications in order to realize the improvement offered by beaming messages in the direction of the destination node. Rather, if even one node is capable of beaming messages, it will reduce the number of nodes in the wireless mesh network that receive and process the message, as well as the traffic carried on the wireless communication medium.

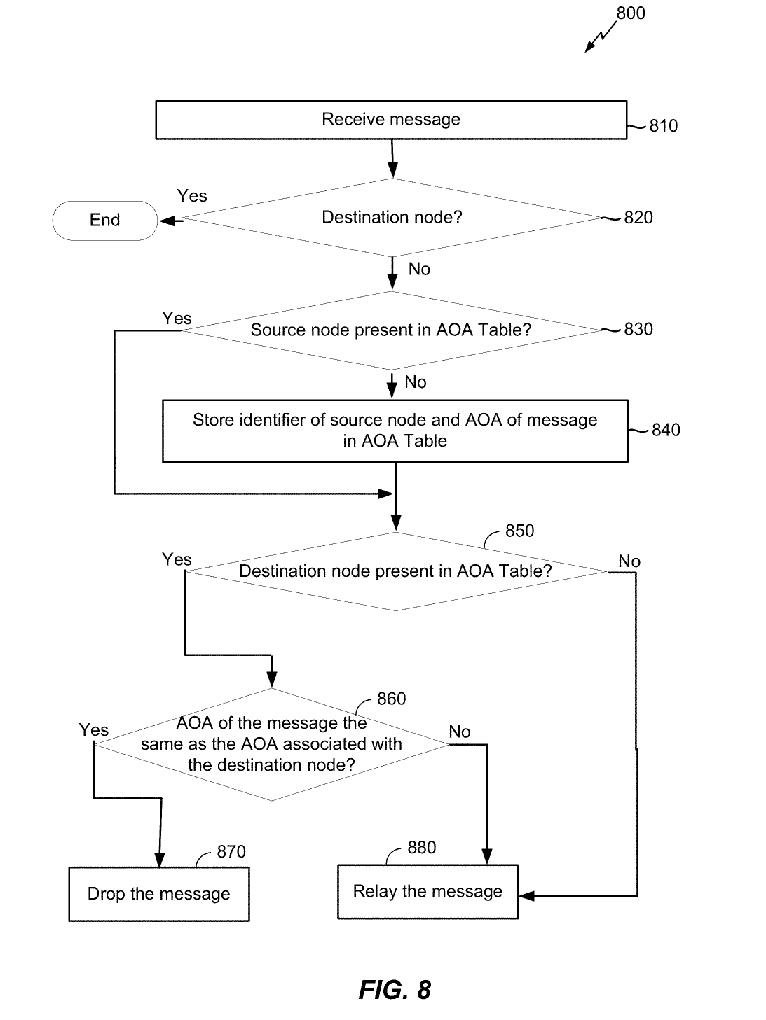

FIG. 8 illustrates an exemplary flow 800 that may be performed by a node in a wireless mesh network according to at least one aspect of the disclosure. At 810, the node receives a message (e.g., mesh application layer packet 410). In an aspect, the node may have originated the message (in which case the node may “receive” the message from a higher layer, another application, a user interface, or the like), received the message from another node in the wireless mesh network, or received it from another device, such as the controller 120 in FIG. 1.

At 820, the node determines whether or not it is the destination node identified in the message (e.g., based on the DST identifier 415 field). If it is, the flow 800 ends and the node processes the message. If it is not, then at 830, the node determines whether or not there is an entry for the source node in its AOA Table. If the identifier of the source node (e.g., SRC identifier 413) is not present in the AOA Table, then at 840, the node creates an entry for the source node that associates the identifier of the source node with the AOA of the message (e.g., <SRC identifier 413, AOA θ>).

If an entry for the source node is present in the AOA Table (“yes” at 830), or after creating the entry for the source node at 840, then at 850, the node determines whether or not there is an entry for the destination node in the node's AOA Table. If there is, then at 860, the node determines whether the destination node is in the direction from which the message arrived based on the AOA of the message. More specifically, as described above, the node identifies the AOA associated with the destination node from the entry for the destination node in the AOA Table and determines whether the AOA of the message is the same as or different from the AOA associated with the destination node. Note that the AOA of the message may be the “same” as the AOA associated with the destination node if the two AOAs are within some threshold of each other. The threshold may be based on the layout of the wireless mesh network. For example, where nodes are located close together, the threshold may be smaller than where the nodes are located further apart. The threshold may also be based on the precision of the AOA associated with the destination node. If the AOA is sufficiently precise, such as where the node received a sufficient number of messages from the source node when generating the AOA Table to precisely determine the AOA of messages from the source node (as discussed above), then the threshold can be smaller than it would be if the AOA associated with the destination node is not as precise.

If the AOA of the message is the same as the AOA associated with the destination node, then at 870, the node drops the message (i.e., does not relay the message). However, if the AOA of the message is not the same as the AOA associated with the destination node, or if the destination node is not present in the AOA Table (“no” at 850), then at 880, the node relays the message. As described above with reference to FIGS. 6 and 7, the node may either broadcast the message omni-directionally (FIG. 6) or beam the message in the direction of the destination node (FIG. 7). If the node can beam the node directionally, but does not have an entry for the destination node in its AOA Table (“no” at 850) and therefore does not know the direction in which to beam the message, the node can broadcast the message omni-directionally. Alternatively, the node can broadcast the message in the opposite direction (at an angle of 180°) from which the message was received.

Note that the flow 800 combines the learning of the AOA associated with the source node with the determination of whether the message came from the direction of the destination node. As will be appreciated, the node may perform the learning portion of the flow 800 (830 and 840) separately from the direction determination portion of the flow 800 (850 to 880). More specifically, the node (and each node in the wireless mesh network) may operate in a learning mode for a period of time in order to generate its AOA Table, and then switch to the direction determination mode after the AOA Table is sufficiently populated and the AOAs are sufficiently refined. In that case, the node may not perform operations 830 and 840. Alternatively, the node can continue to perform operations 830 and 840 in case, for example, a new source node is added to the wireless mesh network after the node switches to the direction determination mode.

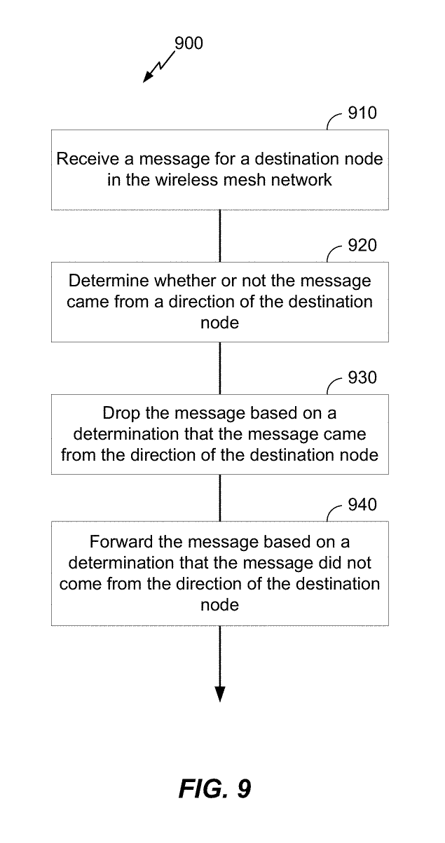

FIG. 9 illustrates an exemplary method 900 for using directionality to reduce flooding in a wireless mesh network according to at least one aspect of the disclosure. At 910, a node of the wireless mesh network receives a message for a destination node in the wireless mesh network, as discussed above with reference to, for example, 810 of FIG. 8. At 920, the node determines whether or not the message came from a direction of the destination node, as discussed above with reference to, for example, 860 of FIG. 8. At 930, the node drops the message based on determining that the message came from the direction of the destination node, as discussed above with reference to, for example, 870 of FIG. 8. At 940, the node forwards the message based on determining that the message did not come from the direction of the destination node, as discussed above with reference to, for example, 880 of FIG. 8.

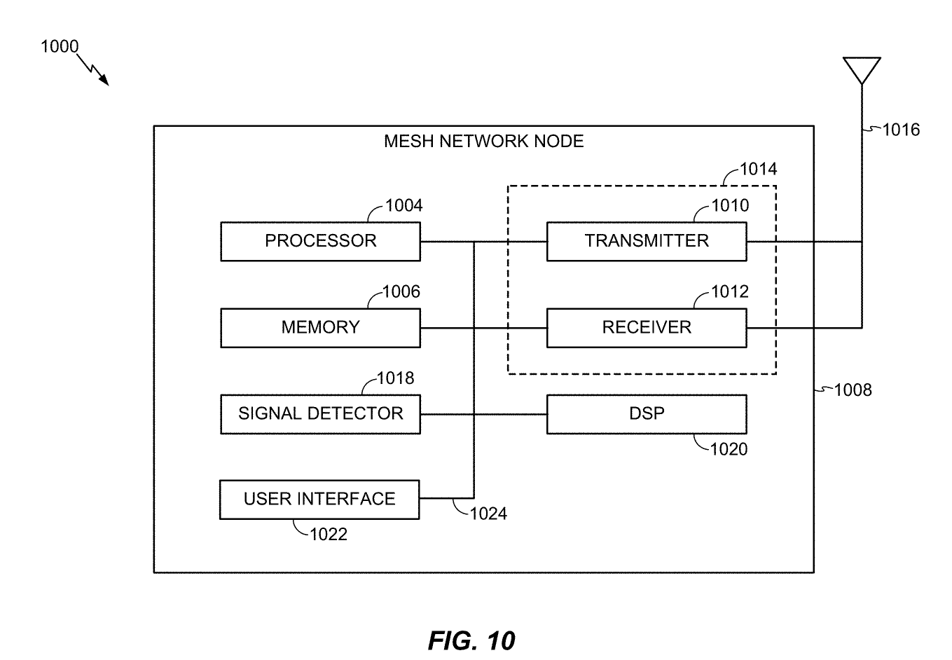

FIG. 10 illustrates an exemplary wireless device 1000 that can be appropriately configured as a node of a wireless mesh network in accordance with the various aspects described herein. For example, the wireless device 1000 may correspond to any one or more of a monitoring node, a transmitting node, a relay node, a destination node, a critical node, a non-functional node, etc. that may be configured to communicate with other nodes in a wireless mesh network as described herein.

In various aspects, the wireless device 1000 can include a processor 1004, a memory 1006, a housing 1008, a transmitter 1010, a receiver 1012, an antenna 1016, a signal detector 1018, a digital signal processor (DSP) 1020, a user interface 1022, and a bus system 1024. Alternatively, the functions of the transmitter 1010 and the receiver 1012 can be incorporated into a transceiver 1014. The wireless device 1000 can be configured to communicate in a wireless network that includes, for example, a base station (not illustrated), an access point (not illustrated), and the like.

In various aspects, the processor 1004 can be configured to control operations of the wireless device 1000. The processor 1004 can also be referred to as a central processing unit (CPU). The memory 1006 can be coupled to the processor 1004, can be in communication with the processor 1004, and can provide instructions and data to the processor 1004. The processor 1004 can perform logical and arithmetic operations based on program instructions stored within the memory 1006. The instructions in the memory 1006 can be executable to perform one or more of the methods and processes described herein. In various aspects, the processor 1004 can include, or be a component of, a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations and/or manipulate information. The processing system can also include machine-readable media for storing software. Software can be construed broadly to mean any type of instructions, whether referred to as software, firmware, middleware, microcode, hardware description language, or otherwise. Instructions can include code, e.g., in source code format, binary code format, executable code format, or any other suitable format of code. The instructions, when executed by the one or more processors, can cause the processing system to perform one or more of the functions described herein.

In various aspects, the memory 1006 can include both read-only memory (ROM) and random access memory (RAM). A portion of the memory 1006 can also include non-volatile random access memory (NVRAM).

In various aspects, the transmitter 1010 and the receiver 1012 (or the transceiver 1014) can allow transmission and reception of data between the wireless device 1000 and a remote location. The antenna 1016 can be attached to the housing 1008 and electrically coupled to the transceiver 1014. In some implementations, the wireless device 1000 can also include multiple transmitters, multiple receivers, multiple transceivers, and/or multiple antennas (not illustrated).

In various aspects, the signal detector 1018 can be used to detect and quantify the level of signals received by the transceiver 1014. The signal detector 1018 can detect such signals as total energy, energy per subcarrier per symbol, and/or power spectral density and in other ways.

In various aspects, the DSP 1020 can be used to process signals. The DSP 1020 can be configured to generate a packet for transmission. In some aspects, the packet can include a physical layer data unit (PPDU).

In various aspects, the user interface 1022 can include, for example, a keypad, a microphone, a speaker, and/or a display. The user interface 1022 can include any element or component that conveys information to a user of the wireless device 1000 and/or receives input from a user.

In various aspects, the various components of the wireless device 1000 can be coupled together by a bus system 1024. The bus system 1024 can include a data bus, and can also include a power bus, a control signal bus, and/or a status signal bus in addition to the data bus.

In various aspects, the wireless device 1000 can also include other components or elements not illustrated in FIG. 10. One or more of the components of the wireless device 1000 can be in communication with another one or more components of the wireless device 1000 by means of another communication channel (not illustrated) to provide, for example, an input signal to the other component.

Although a number of separate components are illustrated in FIG. 10, one or more of the components can be combined or commonly implemented. For example, the processor 1004 and the memory 1006 can be embodied on a single chip. The processor 1004 can additionally, or in the alternative, contain memory, such as processor registers. Similarly, one or more of the functional blocks or portions of the functionality of various blocks can be embodied on a single chip. Alternatively, the functionality of a particular block can be implemented on two or more chips. For example, the processor 1004 can be used to implement not only the functionality described above with respect to the processor 1004, but also to implement the functionality described above with respect to the signal detector 1018 and/or the DSP 1020.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects described herein.

The various illustrative logical blocks, modules, and circuits described in connection with the aspects disclosed herein may be implemented or performed with a general purpose processor, a DSP, an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, electrically erasable programmable ROM (EEPROM), registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects, those skilled in the art will appreciate that various changes and modifications could be made herein without departing from the scope of the disclosure as defined by the appended claims. Furthermore, in accordance with the various illustrative aspects described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method of using directionality to reduce flooding in a wireless mesh network, comprising:
receiving, at a node of the wireless mesh network, a message for a destination node in the wireless mesh network;
determining, by the node, whether or not the message came from a direction of the destination node;
based on determining that the message came from the direction of the destination node, dropping, by the node, the message; and
based on determining that the message did not come from the direction of the destination node, forwarding the message.

2. The method of claim 1, wherein the destination node is identified in the message.

3. The method of claim 1, further comprising:
storing, in an angle of arrival (AOA) table, for each node identified as a source node from which a message is received, an association between an identifier of the source node and an AOA of the message.

4. The method of claim 3, wherein as additional messages are received from a given source node, the AOA associated with the source node is determined with greater precision.

5. The method of claim 3, wherein forwarding the message comprises forwarding the message in the direction of the destination node.

6. The method of claim 5, further comprising determining the direction to the destination node, wherein determining the direction to the destination node comprises determining an AOA associated with the destination node.

7. The method of claim 6, wherein forwarding the message in the direction of the destination node comprises beaming the message along the AOA associated with the destination node.

8. The method of claim 6, wherein determining the AOA to the destination node comprises:
looking up, by the node, an identifier of the destination node in the AOA table; and
retrieving, by the node, the AOA associated with the destination node from the AOA table.

9. The method of claim 5, wherein forwarding the message in the direction of the destination node comprises broadcasting the message in the opposite direction of an AOA of the message.

10. The method of claim 3, wherein determining whether or not the message came from the direction of the destination node comprises:
looking up, by the node, an identifier of the destination node in the AOA table;
retrieving, by the node, the AOA associated with the destination node; and
determining, by the node, whether an AOA of the message is within a threshold of the AOA associated with the destination node.

11. The method of claim 10, wherein the threshold is based on a layout of the wireless mesh network.

12. The method of claim 10, wherein the threshold decreases as additional messages are transmitted and received in the wireless mesh network.

13. The method of claim 3, further comprising:
receiving a plurality of messages having a corresponding plurality of AOAs from the source node; and
identifying one AOA among the plurality of AOAs to associate with the source node.

14. The method of claim 13, wherein each message of the plurality of messages is the same message, and wherein the plurality of messages is received from a plurality of different intermediate nodes.

15. The method of claim 13, wherein each message of the plurality of messages is a different message, and wherein the plurality of messages is received from the same intermediate node.

16. The method of claim 13, wherein the one AOA among the plurality of AOAs is associated with a first arriving message of the plurality of messages.

17. An apparatus for using directionality to reduce flooding in a wireless mesh network, comprising:
a receiver of a node in the wireless mesh network configured to receive a message for a destination node in the wireless mesh network; and
at least one processor of the node configured to:
determine whether or not the message came from a direction of the destination node;
drop the message based on a determination that the message came from the direction of the destination node; and
cause a transmitter of the apparatus to forward the message based on a determination that the message did not come from the direction of the destination node.

18. The apparatus of claim 17, wherein the at least one processor is further configured to:
store, in an angle of arrival (AOA) table, for each node identified as a source node from which a message is received, an association between an identifier of the source node and an AOA of the message.

19. The apparatus of claim 18, wherein as additional messages are received from a given source node, the AOA associated with the source node is determined with greater precision.

20. The apparatus of claim 18, wherein the at least one processor being configured to cause the transmitter to forward the message comprises the at least one processor being configured to cause the transmitter to forward the message in the direction of the destination node.

21. The apparatus of claim 20, wherein the at least one processor is further configured to determine the direction to the destination node, wherein the at least one processor being configured to determine the direction to the destination node comprises the at least one processor being configured to determine an AOA associated with the destination node.

22. The apparatus of claim 21, wherein the at least one processor being configured to cause the transmitter to forward the message in the direction of the destination node comprises the at least one processor being configured to cause the transmitter to beam the message along the AOA associated with the destination node.

23. The apparatus of claim 21, wherein the at least one processor being configured to determine the AOA to the destination node comprises the at least one processor being configured to:
look up an identifier of the destination node in the AOA table; and
retrieve the AOA associated with the destination node from the AOA table.

24. The apparatus of claim 20, wherein the at least one processor being configured to cause the transmitter to forward the message in the direction of the destination node comprises the at least one processor being configured to cause the transmitter to broadcast the message in the opposite direction of an AOA of the message.

25. The apparatus of claim 18, wherein the at least one processor being configured to determine whether or not the message came from the direction of the destination node comprises the at least one processor being configured to:
look up an identifier of the destination node in the AOA table;
retrieve the AOA associated with the destination node; and
determine whether an AOA of the message is within a threshold of the AOA associated with the destination node.

26. The apparatus of claim 25, wherein the threshold is based on a layout of the wireless mesh network.

27. The apparatus of claim 25, wherein the threshold decreases as additional messages are transmitted and received in the wireless mesh network.

28. The apparatus of claim 18, wherein the at least one processor is further configured to:
receive a plurality of messages having a corresponding plurality of AOAs from the source node; and
identify one AOA among the plurality of AOAs to associate with the source node.

29. An apparatus for using directionality to reduce flooding in a wireless mesh network, comprising:
a means for communication of a node in the wireless mesh network configured to receive a message for a destination node in the wireless mesh network; and
a means for processing of the node configured to:
determine whether or not the message came from a direction of the destination node;
drop the message based on a determination that the message came from the direction of the destination node; and
cause a transmitter of the apparatus to forward the message based on a determination that the message did not come from the direction of the destination node.

30. A non-transitory computer-readable medium storing computer-executable instructions for using directionality to reduce flooding in a wireless mesh network, the computer-executable instructions comprising:
at least one instruction instructing a node of the wireless mesh network to receive a message for a destination node in the wireless mesh network;
at least one instruction instructing the node to determine whether or not the message came from a direction of the destination node;
at least one instruction instructing the node to drop the message based on a determination that the message came from the direction of the destination node; and
at least one instruction instructing the node to forward the message based on a determination that the message did not come from the direction of the destination node.
